(19) United States
(12) Patent Application Publication
(10) Pub. No.: US 2025/0206093 A1
(43) Pub. Date: Jun. 26, 2025

(54) SUSPENSION FOR VEHICLE

(71) Applicants: HYUNDAI MOBIS CO., LTD., Seoul (KR); PYUNG HWA INDUSTRIAL CO., LTD., Daegu (KR)

(72) Inventors: Byung Joon CHOI, Yongin-si (KR); Sung Jin WON, Yongin-si (KR); Ho Sung LEE, Daegu (KR); Do Hyun KIM, Daegu (KR)

(73) Assignees: HYUNDAI MOBIS CO., LTD., Seoul (KR); PYUNG HWA INDUSTRIAL CO., LTD., Daegu (KR)

(21) Appl. No.: 18/962,613

(22) Filed: Nov. 27, 2024

(30) Foreign Application Priority Data
Dec. 22, 2023 (KR) 10-2023-0189871

(51) Int. Cl. B60G 15/06

(52) U.S. Cl. CPC B60G 15/067; B60G 2202/30; B60G 2204/128; B60G 2206/41; B60G 2800/162

(57) ABSTRACT

A suspension for a vehicle includes: a bracket coupled to a vehicle body; a bush accommodated in the bracket and configured to allow fluid to flow in response to elastic deformation; an inner core movably coupled to the bush and configured to pressurize the bush; a pipe interposed between the bracket and the bush and surrounding the bush; and an upper part coupled to the bracket and covering the bush.

### CROSS-REFERENCE TO RELATED APPLICATION

The present application claims priority to and the benefit of Korean Patent Application No. 10-2023-0189871, filed on Dec. 22, 2023 in the Korean Intellectual Property Office, the entire disclosure of which is incorporated herein by reference.

### BACKGROUND

### Field

Exemplary embodiments of the present disclosure relate to a suspension for a vehicle, and more particularly, to a suspension for a vehicle, which may enhance riding comfort of the vehicle by both reducing noise, vibration, and harshness (NVH) and improving ride and handling (R&H) performance.

### Description of the Related Art

A suspension for a vehicle typically connects an axle and a body of a vehicle to prevent vibration or impact transmitted from wheels of the vehicle from the road surface from being directly transmitted to the vehicle body when the vehicle is driving, thereby preventing damage to the vehicle body and providing a comfortable ride for a passenger.

In the vehicle suspension, an insulator is installed on a piston rod for coupling with the vehicle body. The insulator includes a bush having a damping function.

However, due to the nature of the bush, it is difficult to both reduce noise, vibration, and harshness (NVH) and improve ride and handling (R&H) performance. Thus, there is a need for improvement to address this issue.

The related art of the present invention is disclosed in Korean Patent Application Publication No. 10-2019-0090310 (published on Aug. 1, 2019 and entitled “SUSPENSION APPARATUS FOR VEHICLE”).

### SUMMARY

Various embodiments are directed to a suspension for a vehicle, which may improve riding comfort of a vehicle by both reducing noise, vibration, and harshness (NVH) and improving ride and handling (R&H) performance.

In an embodiment, a suspension for a vehicle may include: a bracket coupled to a vehicle body; a bush, which is accommodated in the bracket, and in which fluid flows in response to elastic deformation; an inner core movably coupled to the bush and configured to pressurize the bush; a pipe interposed between the bracket and the bush and surrounding the bush; and an upper part coupled to the bracket and covering the bush.

The bush may include: a damper coupled to the inner core, having a chamber accommodating the fluid, and configured to be elastically deformable when the inner core moves; and a fluid guide coupled to the damper and having a flow path, which guides flow of the fluid supplied from the chamber when the damper is elastically deformed.

The bush may further include a reinforcement arranged inside the damper and configured to reinforce rigidity of the damper. The chamber may include: a first chamber arranged on a

first side of the damper and connected to a first end of the flow path; and a second chamber arranged on a second side of the damper and connected to a second end of the flow path.

The first chamber and the second chamber may be arranged at different heights with respect to an axial direction of the bush.

One of the first chamber and the second chamber may be reduced in volume to supply the fluid to the flow path when the damper is elastically deformed. The other of the first chamber and the second chamber may receive the fluid from the flow path to expand in volume when the damper is elastically deformed.

The inner core may include: an inner core body accommodated inside the damper; a first protrusion protruding from a first side of the inner core body and inserted into the damper, and configured to pressurize the first chamber so as to reduce a volume of the first chamber; and a second protrusion protruding from a second side of the inner core body and inserted into the damper, and configured to pressurize the second chamber so as to reduce a volume of the second chamber.

The first protrusion and the second protrusion may be arranged at different heights with respect to the axial direction of the bush.

The flow path may include: a first fluid hole, which is connected to the first chamber, and through which the fluid passes; a second fluid hole, which is connected to the second chamber, and through which the fluid passes; and a flow path groove, which is configured to connect the first fluid hole and the second fluid hole, and in which the fluid flows.

The flow path groove may be arranged spirally along a circumferential direction of the fluid guide.

According to the present disclosure, the vehicle suspension may include the flow path, which guides flow of the fluid, in the bush and utilize elastic characteristics of the damper, which is elastically deformable in response to movement of the inner core, and damping characteristics in response to flow of the fluid. Thus, the vehicle suspension may improve the performance and riding comfort of the vehicle by both reducing noise, vibration, and harshness (NVH) and improving ride and handling (R&H) performance.

In addition, according to the present disclosure, the vehicle suspension may improve damping performance of the damper by increasing the volume change of the chamber when the inner core is moved by the protrusions, which are provided in the inner core and configured to pressurize the chamber.

### BRIEF DESCRIPTION OF THE DRAWINGS

FIG. 1 is a perspective view illustrating a suspension for a vehicle according to embodiments of the present disclosure.

FIG. 2 is an exploded perspective view of FIG. 1.

FIG. 3 is a cross-sectional perspective view taken along line A-A in FIG. 1.

FIG. 4 is a cross-sectional view taken along line A-A in FIG. 1.

FIG. 5 is a perspective view illustrating a bush in the vehicle suspension according to embodiments of the present disclosure.

FIG. 6 is an exploded perspective view of FIG. 5.

FIGS. 7 and 8 are cross-sectional views illustrating an operational status of the vehicle suspension according to embodiments of the present disclosure.

### DETAILED DESCRIPTION

Hereinafter, a suspension for a vehicle will be described below with reference to the accompanying drawings through various exemplary embodiments. It should be considered that the thickness of each line or the size of each component in the drawings may be exaggeratedly illustrated for clarity and convenience of description. In addition, the terms as used herein are defined in consideration of functions of the present disclosure, and these terms may change depending on a user or operator's intention or practice. Therefore, these terms should be defined based on the entirety of the disclosure set forth herein.

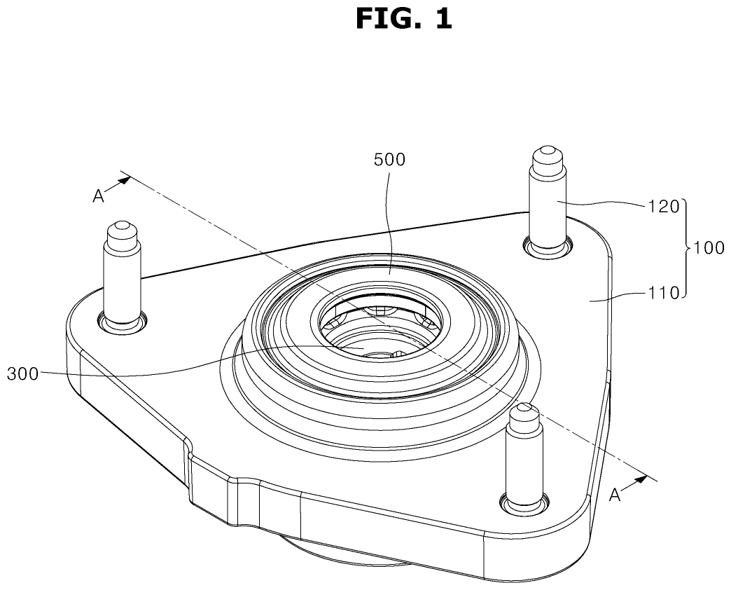

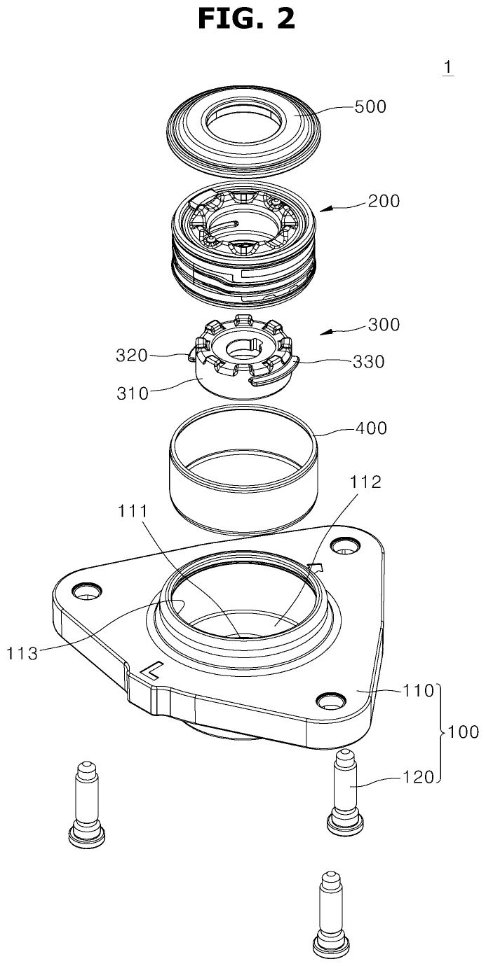

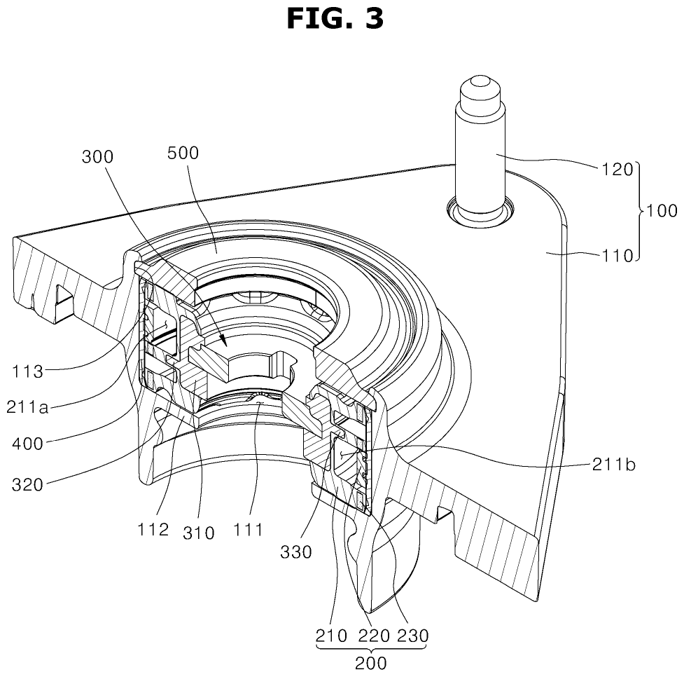

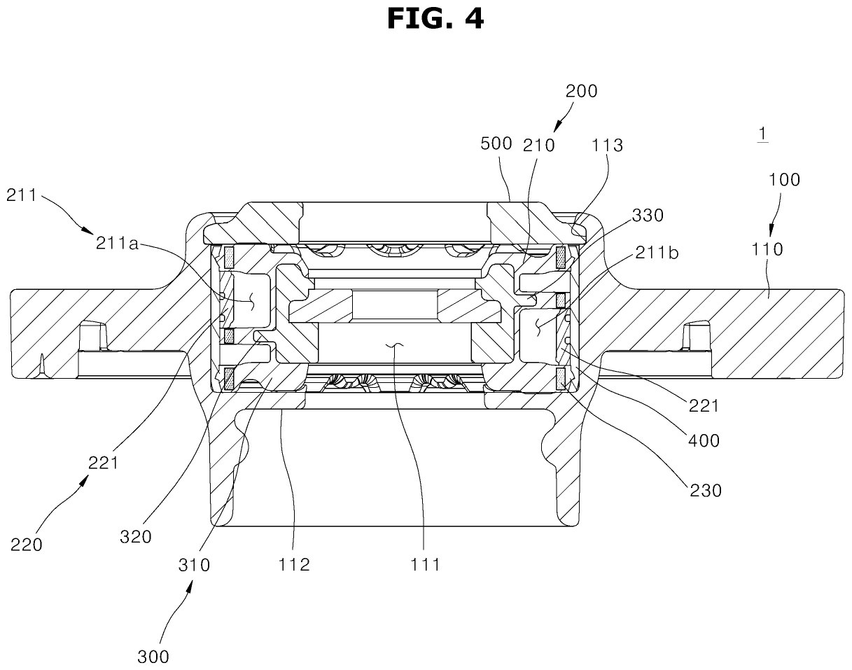

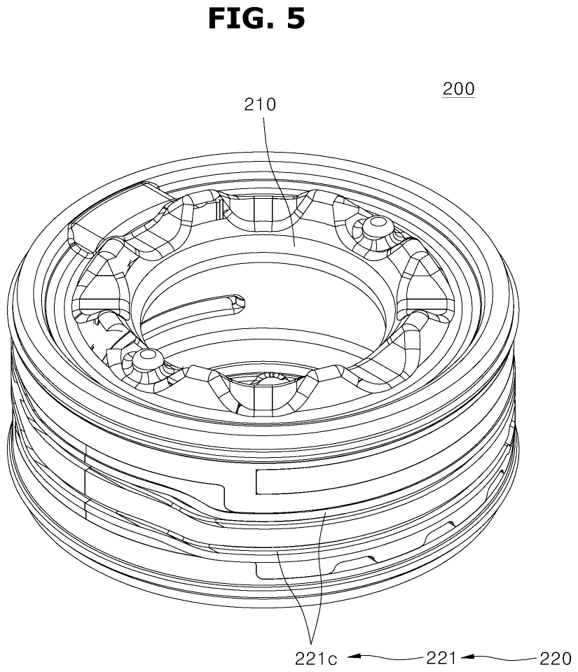

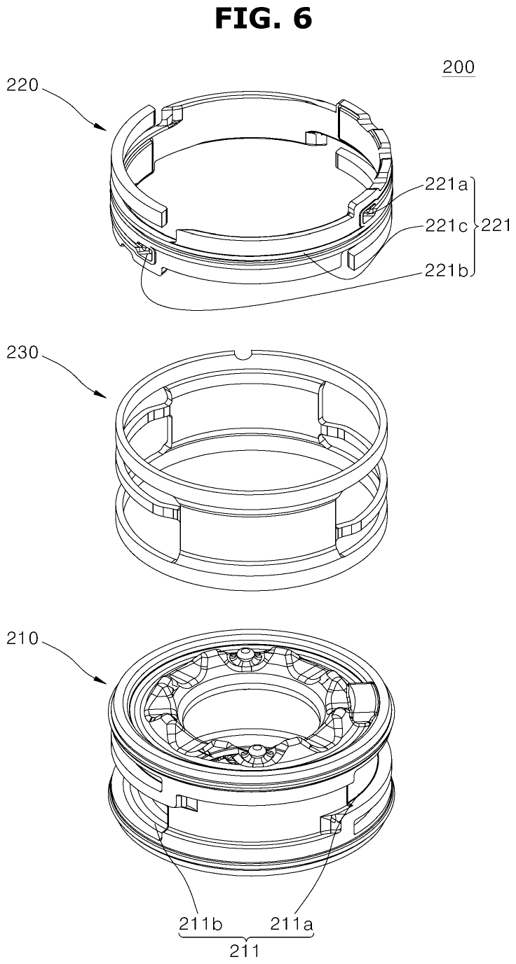

FIG. 1 is a perspective view illustrating a suspension for a vehicle according to embodiments of the present disclosure. FIG. 2 is an exploded perspective view of FIG. 1. FIG. 3 is a cross-sectional perspective view taken along line A-A in FIG. 1. FIG. 4 is a cross-sectional view taken along line A-A in FIG. 1. FIG. 5 is a perspective view illustrating a bush in the vehicle suspension according to embodiments of the present disclosure. FIG. 6 is an exploded perspective view of FIG. 5.

Referring to FIGS. 1 to 6, the vehicle suspension 1 according to embodiments of the present disclosure includes a bracket 100, a bush 200, an inner core 300, a pipe 400, and an upper part 500, which are described in detail as follows.

The bracket 100 is coupled to a vehicle body (not illustrated). The bracket 100 may include a bracket body 110 and a fastening member 120. The bracket body 110 may be arranged to face the vehicle body. The fastening member 120 may be exemplified by a bolt. The fastening member 120 may couple the bracket body 110 to the vehicle body to fix the bracket body 110 to a predetermined position on the vehicle body.

The bracket body 110 may include a through-hole 111, a seating portion 112, and a coupling groove 113. The through-hole 111 may be formed in a center portion of the bracket body 110, and may be formed by penetrating the bracket body 110 in a thickness direction thereof (the vertical direction in FIG. 4).

The seating portion 112 may be formed in the through-hole 111. The seating portion 112 may extend at a predetermined length from an inner peripheral surface of the bracket body 110 toward the center portion of the bracket body 110, and may be formed along a circumferential direction of the bracket body 110. The bush 200 and the pipe 400 may be seated on the seating portion 112.

The coupling groove 113 may be formed on an outer side (the upper side in FIG. 4) of the through-hole 111. The coupling groove 113 may be concavely recessed on an inner surface of the bracket body 110, and may be formed along an edge of the bracket body 110. The upper part 500 may be latch-coupled to the coupling groove 113.

The bush 200 may be accommodated in the bracket 100. The bush 200 may be accommodated in the bracket body 110 and positioned inside the through-hole 111. The bush 200 may be formed in an empty hollow shape such that a center portion thereof may communicate with the through-hole 111.

The bush 200 may be seated on the seating portion 112 to prevent the bush 200 from being dislodged, through the through-hole 111, from the bracket body 110. Fluid may flow in the bush 200 in response to elastic deformation. The bush 200 may include a damper 210, a fluid guide 220, and a reinforcement 230.

The damper 210 may be coupled to the inner core 300. The damper 210 may include an elastically deformable rubber material. The damper 210 may be elastically deformed when the inner core 300 moves.

The damper 210 may include a chamber 211. The chamber 211 is a space for accommodating fluid, and may include a first chamber 211a and a second chamber 211b.

The first chamber 211a may accommodate fluid, and may be arranged on a first side (the left side in FIG. 4) of the damper 210, and may be connected to a first end of the flow path 221, which will be described later.

The second chamber 211b may accommodate fluid, and may be arranged, on a second side (the right side in FIG. 4) of the damper 210, to be spaced apart from the first chamber 211a, and may be connected to a second end of the flow path 221.

The first chamber 211a and the second chamber 211b may be arranged at different heights on the damper 210 with respect to an axial direction of the bush 200. The second chamber 211b may be arranged at a lower position than the first chamber 211a.

When the damper 210 is elastically deformed, one of the first chamber 211a and the second chamber 211b may be reduced in volume to supply the fluid to the flow path 221. In addition, when the damper 210 is elastically deformed, the other of the first chamber 211a and the second chamber 211b may receive the fluid from the flow path 221 to expand in volume.

The fluid guide 220 may be coupled to the damper 210. The fluid guide 220 may include the flow path 221, which guides flow of the fluid supplied from the chamber 211 when the damper 210 is elastically deformed.

The fluid guide 220 may include the flow path 221, which is supplied with the fluid from the chamber 211 when the damper 210 is elastically deformed, and through which the supplied fluid flows. The flow path 221 may include a first fluid hole 221a, a second fluid hole 221b, and a flow path groove 221c.

The first fluid hole 221a is connected to the first chamber 211a so that the fluid may pass therethrough. The first fluid hole 221a is connected to a first end of the flow path groove 221c, and may supply the fluid received from the first chamber 211a to the flow path groove 221c or supply the fluid received from the flow path groove 221c to the first chamber 211a.

The second fluid hole 221b is connected to the second chamber 211b so that the fluid may pass therethrough. The second fluid hole 221b is connected to a second end of the flow path groove 221c, and may supply the fluid received from the second chamber 211b to the flow path groove 221c or supply the fluid received from the flow path groove 221c to the second chamber 211b.

The flow path groove 221c is connected to the first fluid hole 221a and the second fluid hole 221b so that the fluid may flow therethrough. The first end of the flow path groove 221c is connected to the first fluid hole 221a, and the second end of the flow path groove 221c is connected to the second fluid hole 221b so that the fluid may flow therethrough.

The flow path groove 221c may be formed in a spiral shape. The flow path groove 221c may be arranged in a spiral shape along a circumferential direction of the fluid guide 220. Thus, the fluid may flow spirally along the flow path groove 221c toward an axial direction of the fluid guide 220.

The reinforcement 230 may be coupled to the damper 210 and reinforce rigidity of the damper 210. The reinforcement 230 may be arranged inside the damper 210 and integrally coupled to the damper 210, thereby serving to reinforce rigidity of the damper 210 and support the damper 210. Thus, a shape of the damper 210 may be maintained.

The inner core 300 may be coupled to the bush 200. The inner core 300 may be movably coupled to the bush 200 and pressurize the bush 200. The inner core 300 may be positioned inside the bracket 100.

The inner core 300 may be accommodated in the through-hole 111. The inner core 300 may be formed in an empty hollow shape such that a center portion thereof may communicate with the through-hole 111.

The inner core 300 may include a plastic or aluminum material. The inner core 300 may include an inner core body 310, a first protrusion 320, and a second protrusion 330. The inner core body 310 may be accommodated inside the damper 210.

The first protrusion 320 may be protruding from a first side (the left side in FIG. 4) of the inner core body 310. The first protrusion 320 may be inserted into the damper 210 and coupled to the damper 210. The first protrusion 320 may be positioned on one side (the lower side in FIG. 4) of the first chamber 211a, and may pressurize the first chamber 211a to reduce the volume of the first chamber 211a.

The second protrusion 330 may be protruding from a second side (the right side in FIG. 4) of the inner core body 310 so as to be spaced apart from the first protrusion 320. The second protrusion 330 may be inserted into the damper 210 and coupled to the damper 210. The second protrusion 330 may be positioned on one side (the upper side in FIG. 4) of the second chamber 211b, and may pressurize the second chamber 211b to reduce the volume of the second chamber 211b.

The first protrusion 320 and the second protrusion 330 may be arranged at different heights. The second protrusion 330 may be arranged at a higher position than the first protrusion 320.

The pipe 400 may be formed in an empty hollow shape such that a center portion thereof may communicate with the through-hole 111. The pipe 400 may be accommodated in the through-hole 111 and interposed between the bracket body 110 and the bush 200 so as to surround a peripheral portion of the bush 200.

An inner peripheral surface of the pipe 400 may surround the fluid guide 220. Thus, the pipe 400 may prevent the fluid flowing along the flow path 221 from leaking to the outside. The pipe 400 may be seated on the seating portion 112 to prevent the pipe 400 from being dislodged downward, through the through-hole 111, from the bracket body 110.

The upper part 500 may be coupled to the bracket 100, and may cover the bush 200. The upper part 500 may be coupled to the bracket body 110 to cover an outer surface (the top surface in FIG. 3) of the bush 200. The upper part 500 may be formed in an empty hollow shape such that a center portion thereof may communicate with the through-hole 111.

An edge of the upper part 500 may be latch-coupled to the coupling groove 113. Thus, an inflow of foreign substances into the bush 200 may be prevented, and the bush 200 may be prevented from being dislodged upward, through the through-hole 111, from the bracket body 110.

The following is the description of an operation process of the vehicle suspension having the configuration described above according to embodiments of the present disclosure.

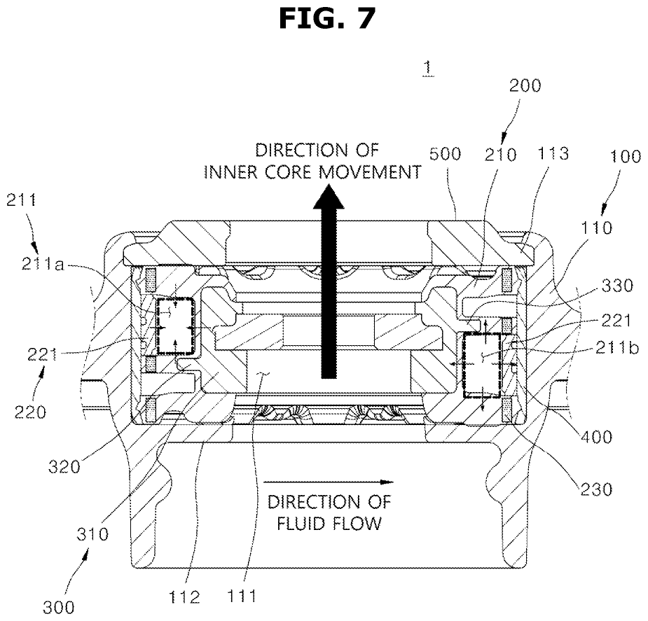

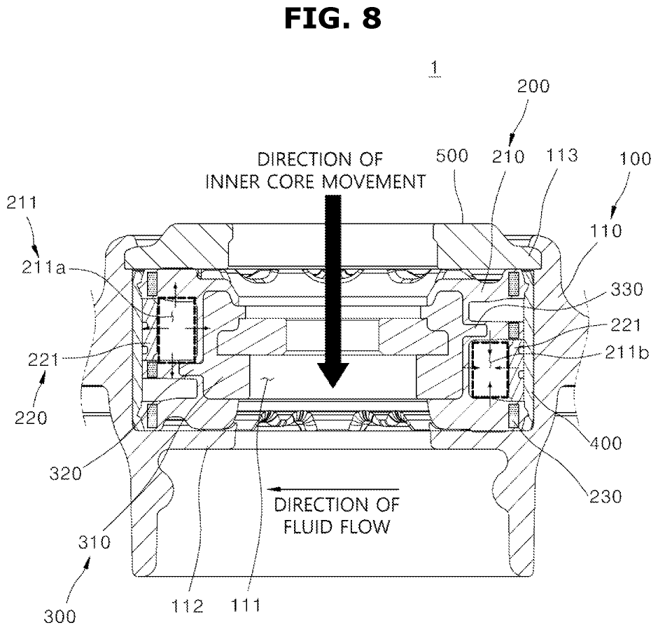

FIGS. 7 and 8 are cross-sectional views illustrating an operation status of the vehicle suspension according to embodiments of the present disclosure.

Referring to FIGS. 1 to 7, in one embodiment, when the vehicle body moves and thus the inner core 300 moves upward, the damper 210 is elastically deformed. At the same time, the first protrusion 320 pressurizes the first chamber 211a upward to reduce the volume of the first chamber 211a. At this time, the fluid accommodated in the first chamber 211a is supplied to the flow path 221. The fluid flowing through the flow path 221 is delivered to the second chamber 211b to expand the volume of the second chamber 211b.

In another embodiment, when the vehicle body moves and thus the inner core 300 moves in one direction (leftward in FIG. 7), the damper 210 is elastically deformed. When the inner core body 310 pressurizes the first chamber 211a, the volume of the first chamber 211a is reduced. At this time, the fluid accommodated in the first chamber 211a is supplied to the flow path 221. The fluid flowing through the flow path 221 is delivered to the second chamber 211b to expand the volume of the second chamber 211b.

Referring to FIGS. 1 to 6 and FIG. 8, in one embodiment, when the vehicle body moves and the inner core 300 moves downward, the damper 210 is elastically deformed. At the same time, the second protrusion 330 pressurizes the second chamber 211b downward to reduce the volume of the second chamber 211b. At this time, the fluid accommodated in the second chamber 211b is supplied to the flow path 221. The fluid flowing through the flow path 221 is delivered to the first chamber 211a to expand the volume of the first chamber 211a.

In another embodiment, when the vehicle body moves and the inner core 300 moves in the other direction (rightward in FIG. 8), the damper 210 is elastically deformed. When the inner core body 310 pressurizes the second chamber 211b, the volume of the second chamber 211b is reduced. At this time, the fluid accommodated in the second chamber 211b is supplied to the flow path 221. The fluid flowing through the flow path 221 is delivered to the first chamber 211a to expand the volume of the first chamber 211a.

The vehicle suspension 1 according to the embodiments of the present disclosures may include the flow path 221, which guides flow of the fluid, in the bush 200 and utilize elastic characteristics of the damper 210, which is elastically deformable in response to movement of the inner core 300, and damping characteristics in response to flow of the fluid. Thus, the vehicle suspension 1 may improve the performance and riding comfort of the vehicle by both reducing noise, vibration, and harshness (NVH) and improving ride and handling (R&H) performance.

The vehicle suspension 1 according to the embodiments of the present disclosures may improve damping performance of the damper 210 by increasing the volume change of the chamber 211 when the inner core 300 is moved by the protrusions 320 and 330, which are provided in the inner core 300 and configured to pressurize the chamber 211.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. A suspension for a vehicle, the suspension comprising:
a bracket coupled to a vehicle body;
a bush accommodated in the bracket, wherein fluid flows in the bush in response to elastic deformation;
an inner core movably coupled to the bush and configured to pressurize the bush;
a pipe interposed between the bracket and the bush and surrounding the bush; and
an upper part coupled to the bracket and covering the bush.

2. The suspension of claim 1, wherein the bush includes:
a damper coupled to the inner core, having a chamber accommodating the fluid, and configured to be elastically deformable when the inner core moves; and
a fluid guide coupled to the damper and having a flow path guiding flow of the fluid supplied from the chamber when the damper is elastically deformed.

3. The suspension of claim 2, wherein the bush further includes a reinforcement arranged inside the damper and configured to reinforce rigidity of the damper.

4. The suspension of claim 3, wherein the chamber includes:
a first chamber arranged on a first side of the damper and connected to a first end of the flow path; and
a second chamber arranged on a second side of the damper and connected to a second end of the flow path.

5. The suspension of claim 4, wherein the first chamber and the second chamber are arranged at different heights with respect to an axial direction of the bush.

6. The suspension of claim 5, wherein:
one of the first chamber and the second chamber is reduced in volume to supply the fluid to the flow path when the damper is elastically deformed, and
the other one of the first chamber and the second chamber receives the fluid from the flow path to expand in volume when the damper is elastically deformed.

7. The suspension of claim 6, wherein the inner core includes:
an inner core body accommodated inside the damper;
a first protrusion protruding from a first side of the inner core body and inserted into the damper, and configured to pressurize the first chamber so as to reduce a volume of the first chamber; and
a second protrusion protruding from a second side of the inner core body and inserted into the damper, and configured to pressurize the second chamber so as to reduce a volume of the second chamber.

8. The suspension of claim 7, wherein the first protrusion and the second protrusion are arranged at different heights with respect to the axial direction of the bush.

9. The suspension of claim 6, wherein the flow path includes:
a first fluid hole connected to the first chamber, wherein the fluid passes through the first fluid hole;
a second fluid hole connected to the second chamber, wherein the fluid passes through the second fluid hole; and
a flow path groove configured to connect the first fluid hole and the second fluid hole, wherein the fluid flows in the flow path groove.

10. The suspension of claim 9, wherein the flow path groove extends spirally along a circumferential direction of the fluid guide.
